(19) United States
(12) Patent Application Publication
(10) Pub. No.: US 2014/0226938 A1
(43) Pub. Date: Aug. 14, 2014

(54) SENSING CABLE

(71) Applicant: AFL TELECOMMUNICATIONS LLC, Duncan, SC (US)

(72) Inventors: Yoshio Hashimoto, Greer, SC (US); Daniel Belouin, Spartanburg, SC (US); Joe Cignarale, Greer, SC (US); Brett Villiger, Simpsonville, SC (US)

(73) Assignee: AFL TELECOMMUNICATIONS LLC, Duncan, SC (US)

(21) Appl. No.: 13/810,821

(22) PCT Filed: Oct. 3, 2012
(86) PCT No.: PCT/US12/58554

§ 371 Date: Jan. 17, 2013

Related U.S. Application Data
(60) Provisional application No. 61/542,538, filed on Oct. 3, 2011.

(51) Int. Cl. G02B 6/44

(52) U.S. Cl. CPC G02B 6/4432
USPC 385/105

(57) ABSTRACT

Provided is a sensing cable including a first protective member which encases a first component, a second protective member having a channel portion which encases a second component. The second protective member includes a crescent shape and the second component is disposed in the channel portion of the second protective member.

### CROSS-REFERENCE TO RELATED APPLICATIONS

This application is based upon and claims the benefit of priority from U.S. Provisional application Ser. No. 61/542,538, filed Oct. 3, 2011, the disclosure of which is incorporated herein in their entirety by reference.

### BACKGROUND OF THE INVENTION

1. Field of the Invention

The invention is related to a cable structure with a component (which is used for fiber-optic sensing, data transmission and so on) and armor around the component. More particularly, the invention is related to a specific armor to provide a stable slot in the longitudinal direction of the component.

2. Background

In the oil and gas downhole field, optical fibers are used for sensing the distribution of temperature. A cable containing an optical fiber covered by Stainless Steel Tube (SST) is well known as a Distributed Temperature Sensor Cable (DTS cable). In this cable structure, the optical fiber is protected by the SST from high pressure and temperature.

Typically, the SST described above is placed at the center of the cable and plural wires surround it. The purposes of the surrounding wires are 1) to protect the optical fibers disposed inside the SST from the external impact or any damage (armoring) and 2) to protect the optical fibers inside the SST from the tension caused during the installation.

In recent years, Brillouin Optical Time Domain Reflectometer (BOTDR) analyzing system for sensing the temperature and pressure distribution at the same time is under the development. The cable used for this system is called Distributed Pressure and Temperature Sensor (DPTS) cable. An example of the cable structure has been described in US 2011/022505. In this invention, an exposed optical fiber which is mainly for pressure sensing is placed at the center of the cable. The pressure sensing optical fiber is surrounded by several wires and an SST containing an optical fiber which is for temperature sensing in the same way as DTS.

In related art, a cable structure is typically provided with a central fiber and at least on layer of armoring wires around the central fiber. An example of the related art as illustrated in FIG. 1 shows the structure with three armoring layers (denoted as 3, 4 and 5). In such structures, the main function of the inner-most layer armor 4 is to protect the central fiber 1 from external forces such as impact, damage or crush except from external water pressure. In other words, the central fiber 1 can measure the external pressure.

For this function, the inner-most layer armor is required to have an inner cross-sectional area in the central fiber longitudinal direction with an inscribed circle shape which has the same diameter of the central fiber or a diameter slightly larger than the diameter of the central fiber. The deformation of the cross-sectional area of the inner-most layer can induce different types of physical force onto the central fiber and damage the central fiber.

A SST with a specific geometry of the exemplary embodiments enables one of ordinary skill in the art an armor layer with longitudinally stable space for a central fiber to protect the fiber from the mechanical impacts.

### BRIEF SUMMARY OF THE INVENTION

Exemplary implementations of the present invention address at least the issues described above and the objects described below. Also, the present invention is not required to address the issues described above or objects described below, and an exemplary implementation of the present invention may not address the issues listed above or objects described below.

An object of the invention is to improve the productivity of an armoring layer which protects the central fiber.

Another object of the invention is to improve a performance of the cable by providing protection for the cable against mechanical impacts.

Another object of the invention is to provide an armor layer which is more robust than that made by an armor of galvanized improved plow wires of related art.

According to an aspect of an exemplary embodiment, there is provided a sensing cable including a first protective member which encases a first component, and a second protective member having a channel portion which encases a second component. The second protective member includes a crescent shape and the second component is disposed in the channel portion of the second protective member.

The sensing cable may also include a first armor layer which encircles the first protective member and the second protective member.

The sensing cable may also include a second armor layer which encircles the second protective member and the second component. The second armor layer includes the first protective member.

The first armor layer encircles the second armor layer.

The sensing cable may also include a second armor layer which encircles the first protective member and the first component. The second armor layer includes the second protective member.

The first and second components may include a material selected from the group consisting of a bare optical fiber, a colored optical fiber, a coated optical fiber, a buffered optical fiber with a plastic and a copper wire.

The first and second components may include a material selected from the group consisting of Polyvinyl chloride (PVC), Polyethylene (PE), Perfluoroalkoxy (PFA or MFA), Polyvinylidene fluoride (PVDF), Tetrafluoroethylene (TEFZEL), TEFLON, Polytetrafluoroethylene (PTFE), Polybutylene terephthalate (PBT) and Polypropylene (PP).

The first and second protective members may include a material selected from the group consisting of any ferrous or non-ferrous metal, Polyvinyl chloride (PVC), Polyethylene (PE), Perfluoroalkoxy (PFA or MFA), Polyvinylidene fluoride (PVDF), Tetrafluoroethylene (TEFZEL), TEFLON, Polytetrafluoroethylene (PTFE), Polybutylene terephthalate (PBT) and Polypropylene (PP).

The channel portion of the second protective member may extend straight in a longitudinal direction of the sensing cable.

The channel portion of the second protective member extends helically in a longitudinal direction of the sensing cable.

The channel portion of the second protective member comprises a S-Z track longitudinally.

According to an aspect of another exemplary embodiment, there is provided a sensing cable including a protective member having a channel portion and a hollow inner part which encases a first component and a second component. The first component is disposed in the hollow inner part of the protective member and the second component is disposed in the channel portion of the second protective member.

The sensing cable may include at least one armor layer which encircles the protective member.

The protective member may include at least two channel portions.

The first and second components may include a material selected from the group consisting of a bare optical fiber, a colored optical fiber, a coated optical fiber, a buffered optical fiber with a plastic and a copper wire.

The first and second components may include a material selected from the group consisting of Polyvinyl chloride (PVC), Polyethylene (PE), Perfluoroalkoxy (PFA or MFA), Polyvinylidene fluoride (PVDF), Tetrafluoroethylene (TEFZEL), TEFLON, Polytetrafluoroethylene (PTFE), Polybutylene terephthalate (PBT) and Polypropylene (PP).

The first and second protective members may include a material selected from the group consisting of any ferrous or non-ferrous metal, Polyvinyl chloride (PVC), Polyethylene (PE), Perfluoroalkoxy (PFA or MFA), Polyvinylidene fluoride (PVDF), Tetrafluoroethylene (TEFZEL), TEFLON, Polytetrafluoroethylene (PTFE), Polybutylene terephthalate (PBT) and Polypropylene (PP).

The channel portion of the protective member may extend straight in a longitudinal direction of the sensing cable.

The channel portion of the protective member may extend helically in a longitudinal direction of the sensing cable.

The channel portion of the protective member may include a S-Z track longitudinally.

According to an aspect of yet another exemplary embodiment, there is provided a sensing cable including a first component, a second component, and a plurality of protective members which forms a circular layer. The first component may be disposed in a hollow inner part of each of the plurality protective member and the second component may be disposed inside of the circular layer of the plurality of protective members.

The sensing cable may include at least one armor layer which encircles the circular protective member layer.

### BRIEF DESCRIPTION OF THE DRAWINGS

The above and other objects, features and advantages of the invention will become more apparent by describing in detail exemplary embodiments thereof with reference to the attached drawings in which:

FIG. 1 shows a cross-sectional view of an example of conventional DPTS cables.

FIG. 2 shows a cross-sectional view of another example of conventional DPTS cables.

FIG. 3 shows a cross-sectional view of an exemplary embodiment of a cylindrical protective member and a crescent-shaped protective member surrounded by wires.

FIG. 4 shows a cross-sectional view of another exemplary embodiment of a cylindrical protective member and a crescent-shaped protective member surrounded by wires.

FIG. 5 shows a cross-sectional view of an exemplary embodiment of an unexposed component disposed in a crescent-shaped protective member and an exposed component disposed inside a channel of the crescent-shaped protective member.

FIG. 6 shows a cross-sectional view of another exemplary embodiment of an unexposed component disposed in a protective member having two channels and exposed components disposed inside the channels of the protective member.

FIGS. 7A-7C shows a cross-sectional view of another exemplary embodiment of an unexposed component disposed in each of a multiple of protective members and an exposed component disposed at the center of the multiple of protective members.

### DETAILED DESCRIPTION OF EXEMPLARY EMBODIMENTS OF THE INVENTION

Exemplary embodiments of the invention will now be described below by reference to the attached Figures. The described exemplary embodiments are intended to assist the understanding of the invention, and are not intended to limit the scope of the invention in any way.

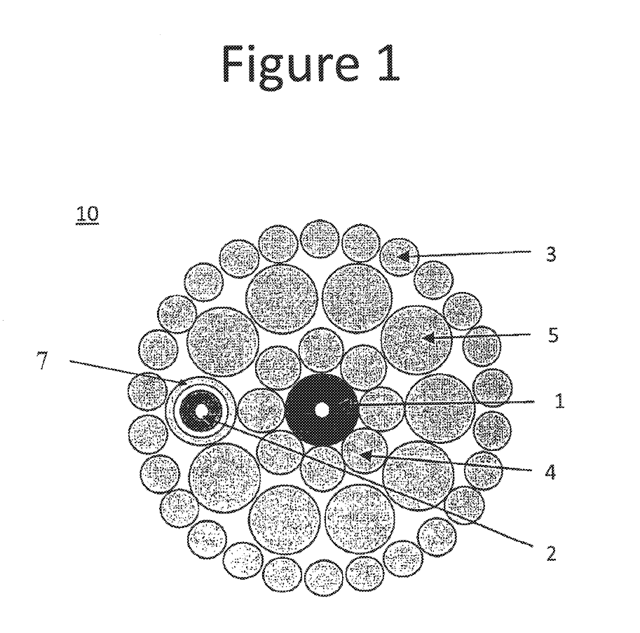

FIG. 1 shows one example of a conventional cable 10. A pressure fiber 1 is arranged at the center of the cable and it is surrounded by galvanized improved plow (GIP) wires 4 as an armor. In the current example, eight (8) GIPs having a range of 0.75˜0.80 mm in diameter are used as a first layer surrounding the pressure fiber 1. A second layer 5 including a temperature measurement optical fiber 2 disposed inside the SST surrounds the first layer. The SST 7 shown in FIG. 1 has no strengthening member inside the metallic tube. In the current embodiment, nine (9) GIPs having a range of 1.15˜1.20 mm in diameter are used as the second layer. Lastly, the pressure fiber and two inner layers 4 and 5 are surrounded by twenty-four (24) GIPs 3 having a range of 0.60˜0.65 mm in diameter.

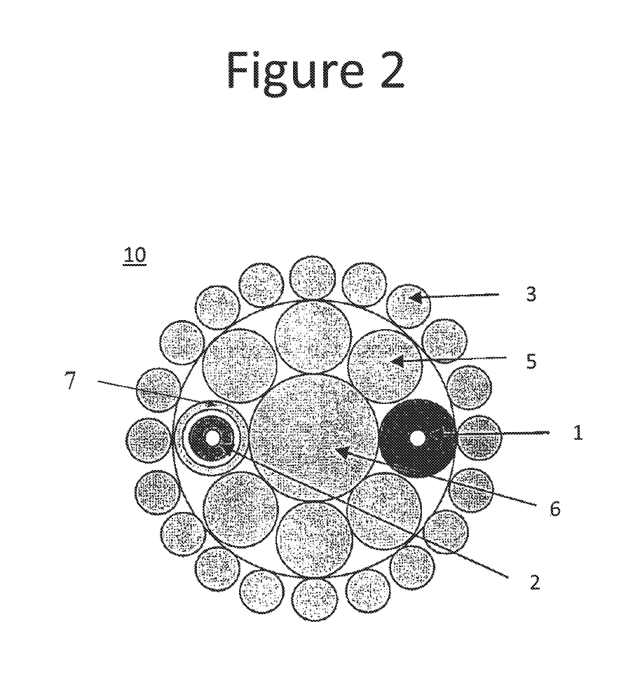

FIG. 2 shows another example of conventional cable 10. Another conventional DPTS has a 1.15˜1.20 mm diameter GIP 6 at the center of the cable and the center GIP 6 is surrounded by six (6) 1.15˜1.20 mm diameter GIP 5, a temperature measuring optical fiber 2 enclosed in a metallic tube 7 with the same diameter as the 1.15˜1.20 mm GIP and a pressure measuring optical fiber 1 with the same diameter as the 1.15˜1.20 mm GIP. In the current embodiment, the metallic tube 7 enclosing a temperature measurement optical fiber 2 does not have any strengthening member inside the metallic tube 7. The six (6) 1.15˜1.20 mm GIPs, the metallic tube 7 enclosing the pressure measuring optical fiber 2, and the temperature measurement optical fiber 1 form a concentric layer surrounding the center GIP 6. The second layer is then surrounded by twenty (20) 0.65˜0.70 mm GIPs 3.

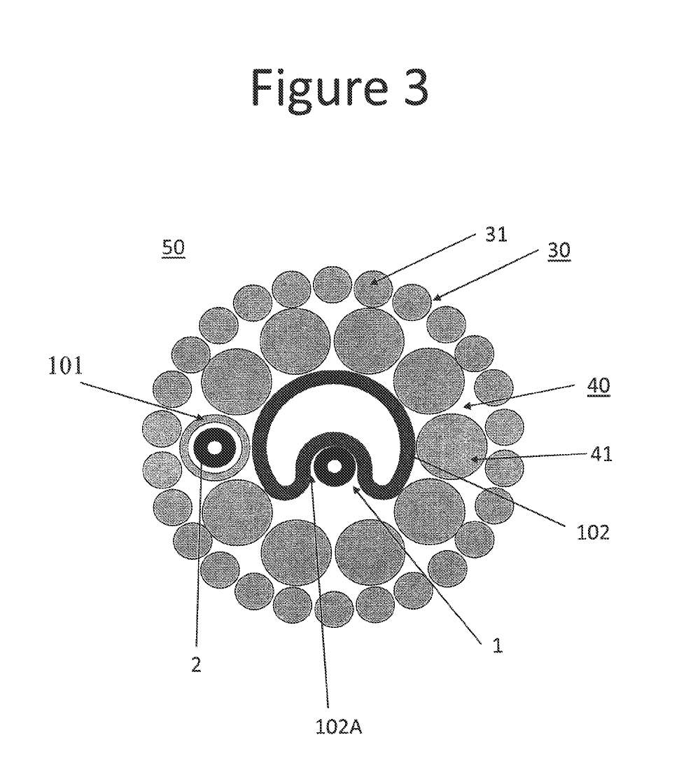

FIG. 3 shows a cross-sectional view of an exemplary embodiment of a cable 50 having a cylindrical protective member 101 and a crescent-shaped protective member 102 surrounded by wires 31. As shown in FIG. 3, the crescent-shaped protective member 102 having a channel portion 102A is disposed at a center of the cable 50. An exposed component 1 is disposed inside the channel portion 102A of the crescent-shaped protective member 102 and the crescent-shaped protective member 102 provides protection of the exposed component 1 from mechanical impact. The exposed component 1 of the current embodiment is a pressure measuring optical fiber, but the current embodiment is not limited thereto. The exposed component may be any type of instrumentation which can be inserted in the channel portion 102A of the crescent-shaped protective member 102.

The crescent-shaped protective member 102 and the exposed component 1 disposed in the center of the cable 50 is encircled by a first layer 40 including wires 41 and the cylindrical protective member 101. The wires 41 of the first layer 40 and the cylindrical protective member 101 have the same outer diameter. The cylindrical protective member 101 has a hollow center and an unexposed component 2 is disposed therein. The cylindrical protective member 101 provides protection against high pressure and temperature for the unexposed component 2. The unexposed component 2 of the current embodiment is a temperature measuring optical fiber, but the current embodiment is not limited thereto. The exposed component may be any type of instrumentation which can be inserted inside of the cylindrical protective member 101.

The crescent-shaped protective member 102, the exposed component 1 disposed in the center of the cable 50 and the first layer encircling the crescent-shaped protective member 102 are surrounded by wires 31 of a second layer 30. As shown in FIG. 3, the first layer 40 and the second layer 30 form a concentric circle around the crescent-shaped protective member 102 and the exposed component 1 disposed in the center of the cable 50.

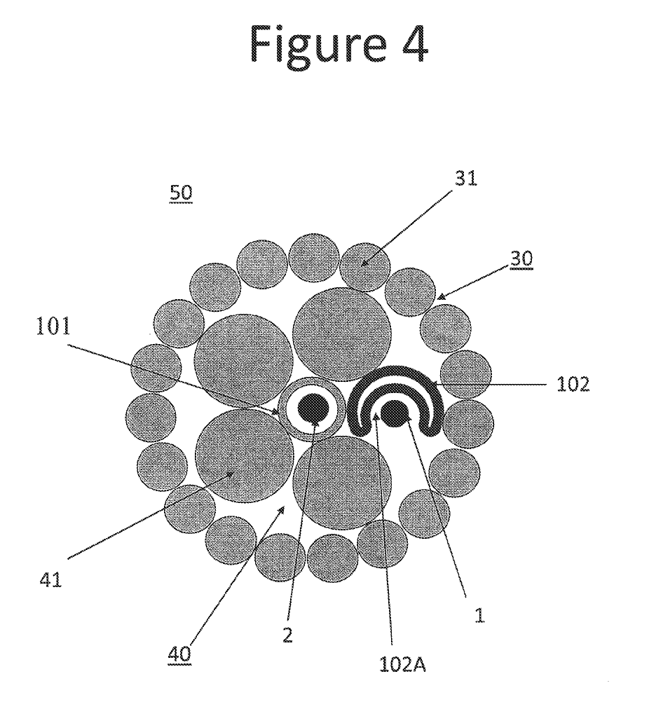

FIG. 4 shows a cross-sectional view of another exemplary embodiment of a cylindrical protective member 101 and a crescent-shaped protective member 102 surrounded by wires 31. Instead of the crescent-shaped protective member 102 and the exposed component 1 disposed in the center of the cable 50 as shown in FIG. 3, the exemplary embodiment shown in FIG. 4 shows a cylindrical protective member 101 having a hollow center and an unexposed component 2 is disposed therein disposed at the center of the cable 50. The cylindrical protective member 101 provides protection against high pressure and temperature for the unexposed component 2. The unexposed component 2 of the current embodiment is a temperature measuring optical fiber, but the current embodiment is not limited thereto. The exposed component may be any type of instrumentation which can be inserted inside of the cylindrical protective member 101.

The cylindrical protective member 101 and the unexposed component 2 is encircled by a first layer 40 having wires 41 and the crescent-shaped protective member 102. An exposed component 1 is disposed inside the channel portion 102A of the crescent-shaped protective member 102 and the crescent-shaped protective member 102 protects the exposed components 1 from the mechanical impact. The exposed component 1 of the current embodiment is a pressure measuring optical fiber, but the current embodiment is not limited thereto. The exposed component may be any type of instrumentation which can be inserted in the channel portion 102A of the crescent-shaped protective member 102.

The cylindrical protective member 101, the unexposed component 2 disposed in the center of the cable 50 and the first layer encircling the cylindrical protective member 101 are surrounded by wires of a second layer 30. As shown in FIG. 4, the first layer 40 and the second layer 30 form a concentric circle around the cylindrical protective member 101 and the unexposed component 1 disposed in the center of the cable 50.

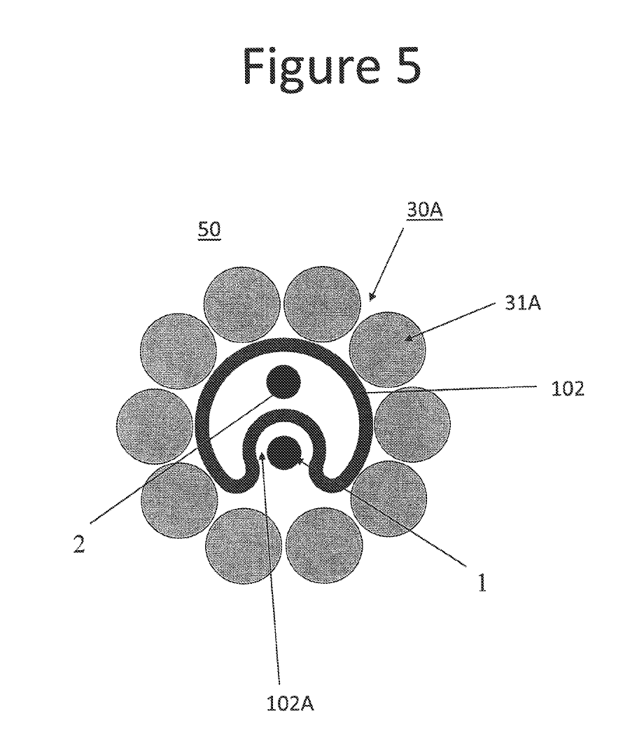

FIG. 5 shows a cross-sectional view of an exemplary embodiment of an unexposed component disposed in a crescent-shaped protective member and an exposed component disposed inside a channel of the crescent-shaped protective member. As shown in FIG. 5, the crescent-shaped protective member 102 having a channel portion 102A is disposed at a center of the cable 50.

The crescent-shaped protective member 102 in the current example shows a hollow inner part and an unexposed component 2 is disposed in the hollow inner part of the crescent-shaped protective member 102 and an exposed component 1 disposed in the channel portion 102A of the crescent-shaped protective member 102. In the current exemplary embodiment, the crescent-shaped protective member 102 protects the exposed component 1 from the mechanical impact. The protective member 102 also protects the unexposed component 2 from the mechanical impact and pressure.

The crescent-shaped protective member 102, the unexposed component 2 disposed inside the hollow inner part of the crescent-shaped protective member 102 and the exposed component 1 disposed in the channel portion 102A of the crescent-shaped protective member 102 are surrounded by a first layer 30A including wires 31A.

In the exemplary embodiments described above, the exposed and unexposed components are selected from a bare optical fiber, a colored optical fiber, a coated optical fiber, or a buffered optical fiber. Both the cylindrical and crescent-shaped protective members may be made of any ferrous or non-ferrous metal, or any type of plastic such as Polyvinyl chloride (PVC), Polyethylene (PE), Perfluoroalkoxy (PFA or MFA), Polyvinylidene fluoride (PVDF), Tetrafluoroethylene (TEFZEL), TEFLON, Polytetrafluoroethylene (PTFE), Polybutylene terephthalate (PBT) and Polypropylene (PP), which are well known in the art.

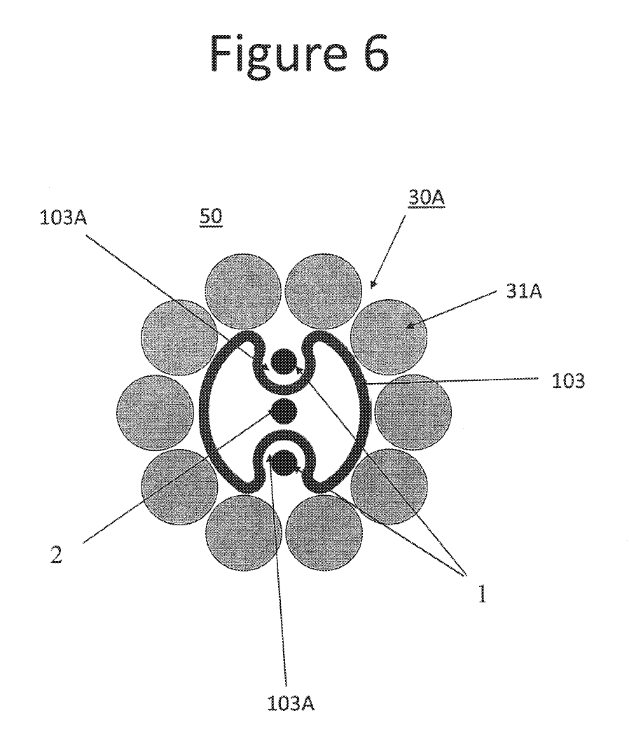

FIG. 6 shows a cross-sectional view of another exemplary embodiment of an unexposed component 2 disposed in a protective member 103 having two channels 103A and exposed components 1 disposed inside the channels of the protective member. The protective member 103 having channel portions 103A is disposed at a center of the cable 50.

The protective member 103 in the current example shows a hollow inner part and an unexposed component 2 is disposed in the hollow inner part of the protective member 103 and exposed components 1 disposed in the channel portions 103A of the protective member 103. In the current exemplary embodiment, the protective member 103 protects two exposed components 1 from the mechanical impact. The protective member 103 also protects the unexposed component 2 from the mechanical impact and pressure.

The protective member 103, the unexposed component 2 disposed inside the hollow inner part of the protective member 103 and the two exposed components 1 disposed in the channel portions 103A of the protective member 103 are surrounded by a first layer 30A including wires 31A.

The channel 102A of FIGS. 3, 4 and 5 and the channels 103A of FIG. 6 may extend in straight line in the longitudinal direction of the cable 50. However, the orientations of the channels 102A and 103A are not limited thereto. The channels 102A and 103A may extend in a helical manner in the longitudinal direction of the cable 50. The channels 102A and 103A may include S-Z track longitudinally.

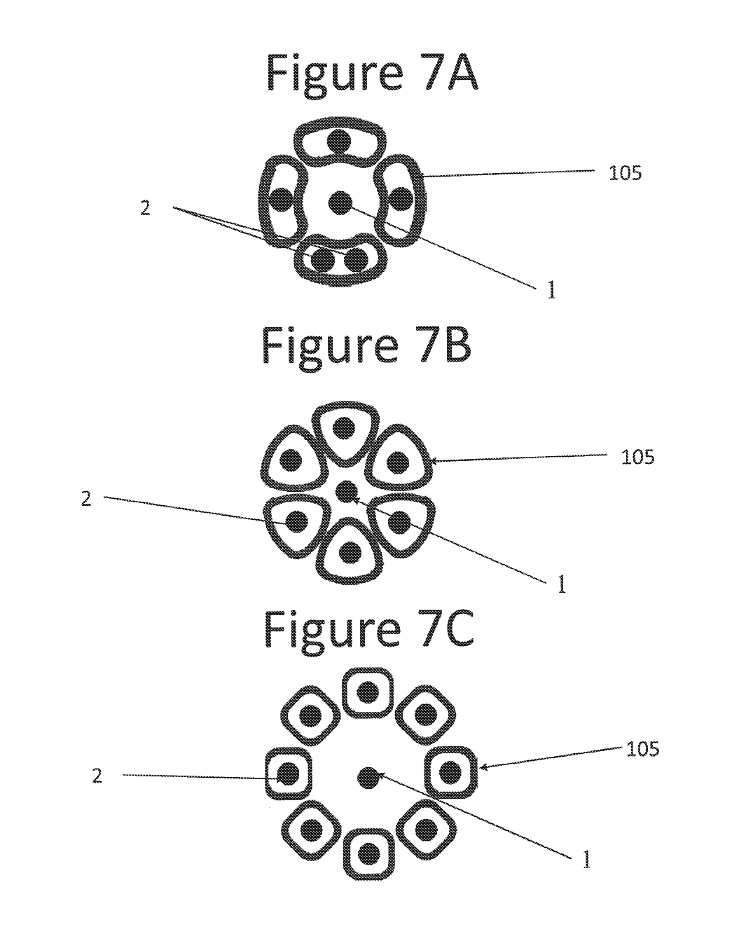

FIGS. 7A-7C show cross-sectional views of exemplary embodiments of an unexposed component disposed in each of a multiple of protective members and an exposed component disposed at the center of the multiple of protective members. Instead of a cable 50 having only one protective member 102 and 103 as shown in FIGS. 5 and 6, the embodiments shown in FIGS. 7A-7C show a multiple of protective members, each encasing an unexposed components and the multiple of protective members forming a armor layer which encircles an exposed component.

As shown in FIGS. 7A-7C, the multiple of protective members may take different shape such as a fan shape (FIG. 7A), a triangle (FIG. 7B) and a square (FIG. 7C). However, many other types of the protective members 105 may be used and arranged to encircle the exposed component 2.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

What is claimed is:

1. A sensing cable comprising:
a first protective member which encases a first component; and
a second protective member having a channel portion which encases a second component,
wherein the second protective member comprises a crescent shape and the second component is disposed in the channel portion of the second protective member.

2. The sensing cable claimed in claim 1 further comprising a first armor layer which encircles the first protective member and the second protective member.

3. The sensing cable claimed in claim 2 further comprising a second armor layer which encircles the second protective member and the second component,
wherein the second armor layer comprises the first protective member.

4. The sensing cable claimed in claim 3,
wherein the first armor layer encircles the second armor layer.

5. The sensing cable claimed in claim 2 further comprising a second armor layer which encircles the first protective member and the first component,
wherein the second armor layer comprises the second protective member.

6. The sensing cable claimed in claim 5,
wherein the first armor layer encircles the second armor layer.

7. The sensing cable claimed in claim 1, wherein the first and second components comprise a material selected from the group consisting of a bare optical fiber, a colored optical fiber, a coated optical fiber, a buffered optical fiber with a plastic and a copper wire.

8. The sensing cable claimed in claim 7, wherein the first and second components further comprise a material selected from the group consisting of Polyvinyl chloride (PVC), Polyethylene (PE), Perfluoroalkoxy (PFA or MFA), Polyvinylidene fluoride (PVDF), Tetrafluoroethylene (TEFZEL), TEFLON, Polytetrafluoroethylene (PTFE), Polybutylene terephthalate (PBT) and Polypropylene (PP).

9. The sensing cable claimed in claim 1, wherein the first and second protective members comprise a material selected from the group consisting of any ferrous or non-ferrous metal, Polyvinyl chloride (PVC), Polyethylene (PE), Perfluoroalkoxy (PFA or MFA), Polyvinylidene fluoride (PVDF), Tetrafluoroethylene (TEFZEL), TEFLON, Polytetrafluoroethylene (PTFE), Polybutylene terephthalate (PBT) and Polypropylene (PP).

10. The cable claimed in claim 1 wherein the channel portion of the second protective member extends straight in a longitudinal direction of the sensing cable.

11. The cable claimed in claim 1 wherein the channel portion of the second protective member extends helically in a longitudinal direction of the sensing cable.

12. The cable claimed in claim 1 wherein the channel portion of the second protective member comprises a S-Z track longitudinally.

13. A sensing cable comprising:
a protective member having a channel portion and a hollow inner part which encases a first component and a second component,
wherein the first component is disposed in the hollow inner part of the protective member and the second component is disposed in the channel portion of the second protective member.

14. The sensing cable claimed in claim 13 comprising at least one armor layer which encircles the protective member.

15. The sensing cable claimed in claim 13, wherein the protective member comprises at least two channel portions.

16. The sensing cable claimed in claim 13, wherein the first and second components comprise a material selected from the group consisting of a bare optical fiber, a colored optical fiber, a coated optical fiber, a buffered optical fiber with a plastic and a copper wire.

17. The sensing cable claimed in claim 16, wherein the first and second components further comprise a material selected from the group consisting of Polyvinyl chloride (PVC), Polyethylene (PE), Perfluoroalkoxy (PFA or MFA), Polyvinylidene fluoride (PVDF), Tetrafluoroethylene (TEFZEL), TEFLON, Polytetrafluoroethylene (PTFE), Polybutylene terephthalate (PBT) and Polypropylene (PP).

18. The sensing cable claimed in claim 13, wherein the first and second protective members comprise a material selected from the group consisting of any ferrous or non-ferrous metal, Polyvinyl chloride (PVC), Polyethylene (PE), Perfluoroalkoxy (PFA or MFA), Polyvinylidene fluoride (PVDF), Tetrafluoroethylene (TEFZEL), TEFLON, Polytetrafluoroethylene (PTFE), Polybutylene terephthalate (PBT) and Polypropylene (PP).

19. The cable claimed in claim 13, wherein the channel portion of the protective member extends straight in a longitudinal direction of the sensing cable.

20. The cable claimed in claim 13, wherein the channel portion of the protective member extends helically in a longitudinal direction of the sensing cable.

21. The cable claimed in claim 13, wherein the channel portion of the protective member comprises a S-Z track longitudinally.

22. A sensing cable comprising:
a first component;
a second component; and
a plurality of protective members which forms a circular layer,
wherein the first component is disposed in a hollow inner part of each of the plurality protective member and the second component is disposed inside of the circular layer of the plurality of protective members.

23. The sensing cable claimed in claim 22 further comprising at least one armor layer which encircles the circular protective member layer.
